(19) United States
(12) Patent Application Publication
(10) Pub. No.: US 2021/0082034 A1
(43) Pub. Date: Mar. 18, 2021

(54) METHOD FOR AUTOMATIC SHOPPING IN SHOPPING MALL, STORAGE MEDIUM, ELECTRONIC DEVICE, AND DEVICE

(71) Applicant: Wuyi University, Jiangmen (CN)

(72) Inventors: Junying ZENG, Jiangmen (CN); Boyuan ZHU, Jiangmen (CN); Fan WANG, Jiangmen (CN); Chuanbo QIN, Jiangmen (CN); Junying GAN, Jiangmen (CN); Yikui ZHAI, Jiangmen (CN)

(21) Appl. No.: 16/806,707

(22) Filed: Mar. 2, 2020

(30) Foreign Application Priority Data
Sep. 18, 2019 (CN) 2019108822666

(51) Int. Cl. G06Q 30/06; G06Q 20/28

(52) U.S. Cl. CPC G06Q 30/0639; G06Q 20/28

(57) ABSTRACT

A method for automatic shopping in a shopping mall, a storage medium, an electronic device, and a device are disclosed. After a consumer selects commodities from an input means, a path along which a moving means needs to travel to pick up the commodities from a shelf is planned on a global map according to first coordinates carried in commodity information, then the moving means is controlled to automatically walk in the shopping mall according to the planned path, the height of lifting means is adjusted according to height values of the corresponding commodities on the shelf, and when the moving means arrives at designated positions on the path, a pickup means on the lifting means picks up the commodities selected by the consumer from the shelf.

### CROSS-REFERENCE TO RELATED APPLICATIONS

This application is based on and claims the benefit of priority from Chinese Patent Application No. 2019108822666, filed on 18 Sep. 2019, the entirety of which is incorporated by reference herein.

### TECHNICAL FIELD

The present disclosure relates to the technical field of intelligent shopping, and in particular, to a method for automatic shopping in a shopping mall, a storage medium, an electronic device, and a device.

### BACKGROUND

In related arts, an intelligent shopping system uses a shopping guide robot or an intelligent shopping guide cart to provide shopping guide service for users shopping in a shopping mall. Through commodity information entered by the users, the shopping guide robot or the intelligent shopping guide cart guides customers to shelves where selected commodities are located, thus reducing the cost for users to search for commodities in a large shopping mall.

In the process of shopping, while guiding the consumers to walk together in a supermarket, the shopping guide robot or the intelligent shopping guide cart uses sensors to observe the surrounding environment and estimate their current pose for localization, finally guiding the consumers to the shelves where the selected commodities are located.

However, in the process of walking, the results of observation and pose estimation of the shopping guide robot or the intelligent shopping guide cart are prone to large errors due to blockage by the consumers or collision, resulting in a poor localization effect, and the consumers still need to take too much effort to search for commodities.

### SUMMARY

The present disclosure aims at solving at least one of the technical problems existing in the prior art. To this end, the present disclosure provides a method for automatic shopping in a shopping mall, a storage medium and an electronic device, which can improve the localization accuracy of an automatic shopping cart and reduce the cost for consumers to search for commodity positions when shopping in the shopping mall.

The present disclosure further proposes a device for automatic shopping in a shopping mall, which can help the consumers automatically find selected commodities in the shopping mall and pick up them from a shelf without requiring the consumers to go to the shelf to pick up the commodities, thus reducing the interference of the consumers with the shopping guide robot or the intelligent shopping guide cart, improving the localization accuracy of the automatic shopping cart and reducing the cost for the consumers to search for commodity positions when shopping in the shopping mall.

A method for automatic shopping in a shopping mall is provided in an embodiment according to a first aspect of the present disclosure, including:

acquiring commodity information of several selected commodities;

planning a path based on first coordinates carried in the commodity information of the several selected commodities;

sending, based on the path, a movement instruction for controlling a moving means to move;

sending, based on height values of the several selected commodities on a shelf which are carried in the commodity information of the selected commodities, a lifting instruction for controlling a lifting means to lift; and

acquiring position information of the moving means and height information of the lifting means, determining whether the position information corresponds to designated positions on the path and whether the height information corresponds to the corresponding height values, and if yes, sending an automatic pickup command to control a pickup means to pick up the commodities from the shelf.

The method for automatic shopping in a shopping mall according to the embodiment of the present disclosure has at least the following beneficial effects: after a consumer selects commodities, a path along which the moving means need to travel to pick up the commodities from a shelf is planned according to first coordinates carried in commodity information, then the moving means is controlled to automatically walk in the shopping mall according to the planned path, the height of the lifting means is adjusted according to height values of the corresponding commodities on the shelf, and when the moving means arrives at designated positions on the path, the pickup means on the lifting means picks up the commodities selected by the consumer from the shelf. After the moving means is controlled to complete the path according to the above process, a shopping cart or shopping robot with the moving means can help the consumer complete the shopping process in the shopping mall without manual intervention after the consumer selects the commodities. The method can avoid the interference with localization of the shopping cart or shopping robot when the consumer and the shopping cart or shopping robot walk together in the shopping mall, thus improving the localization accuracy of the shopping cart or shopping robot. Further, manual pickup operations of the consumer during shopping are eliminated, thus saving the consumer’ time cost.

A computer readable storage medium having a computer program stored thereon is provided in an embodiment according to a second aspect of the present disclosure, wherein when the computer program is executed by a processor, the method for automatic shopping in a shopping mall in the embodiment of the first aspect of the present disclosure is performed. Therefore, the embodiment of the second aspect of the present disclosure has all the beneficial effects of the embodiment of the first aspect of the present disclosure.

An electronic device is provided in an embodiment according to a third aspect of the present disclosure, including: one or more processors; and a storage device for storing one or more programs which, when executed by the one or more processors, cause the one or more processors to perform the method for automatic shopping in a shopping mall in the embodiment of the first aspect of the present disclosure. Therefore, the embodiment of the third aspect of the present disclosure has all the beneficial effects of the embodiment of the first aspect of the present disclosure.

A device for automatic shopping in a shopping mall is provided in an embodiment according to a fourth aspect of the present disclosure, including:

a mechanical body including:

a moving means provided with a movement driving means for driving the moving means to walk,

a lifting means provided with a lift driving means for driving the lifting means to lift, and

a pickup means provided with a pickup driving means for driving the pickup means to operate;

an input means for receiving consumers' selection of commodities;

a memory storing one or more computer programs and a global map; and

one or more processors for executing the computer programs to:

acquire commodity information of several selected commodities sent by the input means;

plan a path in the global map based on first coordinates carried in the commodity information of the several selected commodities;

control, by the processor based on the path, the movement driving means to drive the moving means to move according to the path;

control, by the processor based on height values of the several selected commodities on a shelf which are carried in the commodity information of the selected commodities, the lift driving means to driving the lifting means to lift according to the height values; and

determine, by the processor according to acquired position information of the moving means and height information of the lifting means, whether the position information corresponds to designated positions on the path and whether the height information corresponds to the corresponding height values, and if yes, control the pickup driving means to drive the pickup means to operate to pick up the commodities from the shelf.

The device for automatic shopping in a shopping mall according to the embodiment of the present disclosure has at least the following beneficial effects: after a consumer selects commodities from an input means, a path along which the moving means needs to travel to pick up the commodities from a shelf is planned on a global map according to first coordinates carried in commodity information, then the moving means is controlled to automatically walk in the shopping mall according to the planned path, the height of the lifting means is adjusted according to height values of the corresponding commodities on the shelf, and when the moving means arrives at designated positions on the path, the pickup means on the lifting means picks up the commodities selected by the consumer from the shelf. After the moving means is controlled to complete the path according to the above process, a shopping cart or shopping robot with the moving means can help the consumer complete the shopping process in the shopping mall without manual intervention after the consumer selects the commodities. The method can avoid the interference with localization of the shopping cart or shopping robot when the consumer and the shopping cart or shopping robot walk together in the shopping mall, thus improving the localization accuracy of the shopping cart or shopping robot. Further, manual pickup operations of the consumer during shopping are eliminated, thus saving the consumer time cost.

Additional aspects and advantages of the present disclosure will be given in the following description, and some of which will become apparent from the following description or will be understood by practice of the present disclosure.

### BRIEF DESCRIPTION OF THE DRAWINGS

The above and/or additional aspects and advantages of the present disclosure will become obvious and easy to understand from the description of the embodiments with reference to the following accompanying drawings, in which:

FIG. 1 is a flowchart of a method for automatic shopping in a shopping mall according to an embodiment of the present disclosure;

FIG. 2 is a method flowchart of planning a path in a method for automatic shopping in a shopping mall according to an embodiment of the present disclosure;

FIG. 3 is a method flowchart of adjusting pose of a moving means in a method for automatic shopping in a shopping mall according to an embodiment of the present disclosure;

FIG. 4 is a schematic diagram of a localization solution for the moving means in a method for automatic shopping in a shopping mall according to an embodiment of the present disclosure;

FIG. 5 is a schematic diagram of a localization solution for the moving means in a method for automatic shopping in a shopping mall according to another embodiment of the present disclosure;

FIG. 6 is a schematic structural diagram of a device for automatic shopping in a shopping mall according to an embodiment of the present disclosure;

FIG. 7 is a system block diagram of a device for automatic shopping in a shopping mall according to an embodiment of the present disclosure; and

FIG. 8 is a system block diagram of a device for automatic shopping in a shopping mall according to another embodiment of the present disclosure.

### REFERENCE NUMERALS

moving means 200, chassis 210, wheel 220, lifting means 300, pickup means 400, accommodation space 500, ranging sensor 600, circuit board 700, third wireless communication module 710, first wireless communication module 720, mechanical body 800, movement driving means 820, lift driving means 830, pickup driving means 840, ranging sensor 850, electronic device 910, fourth wireless communication module 911, input means 920, and second wireless communication module 921.

### DETAILED DESCRIPTION

Embodiments of the present disclosure will be described below in detail, examples of which are shown in the accompanying drawings, where identical or similar reference numerals consistently denote identical or similar elements or elements having identical or similar functions. The embodiments described below with reference to the accompanying drawings are exemplary and are used only to interpret the disclosure and cannot be understood as limitations to the disclosure.

In the description of the present disclosure, it should be understood that orientation descriptions involved, for example, orientation or position relationships indicated by up, left, front, and so on, are based on the orientation or position relationships shown in the accompanying drawings, and they are intended only to facilitate the description of the present disclosure and simplify the description, rather than indicating or implying that the means or elements referred to must have a specific orientation and be constructed and operated in a specific orientation, and thus cannot be understood as limiting the present disclosure.

In the description of the present disclosure, “several” means one or more, and “a plurality of” means more than two, “greater than, less than, more than, etc.,” are understood as not including the number itself, while “above, below, within, etc.,” are understood as including the number itself. It should be noted that the terms first, second, third and fourth are described are only used to distinguish technical features rather than being understood as indicating or implying relative importance or implicitly indicating the number of technical features indicated or implicitly indicating the precedence of the technical features indicated.

In the description of the present disclosure, unless otherwise clearly defined, the terms such as “arrange”, “install” and “connect” shall be understood in a broad sense. A person skilled in the art can reasonably determine the specific meanings of the above terms in the present disclosure in combination with specific contents of the technical solution.

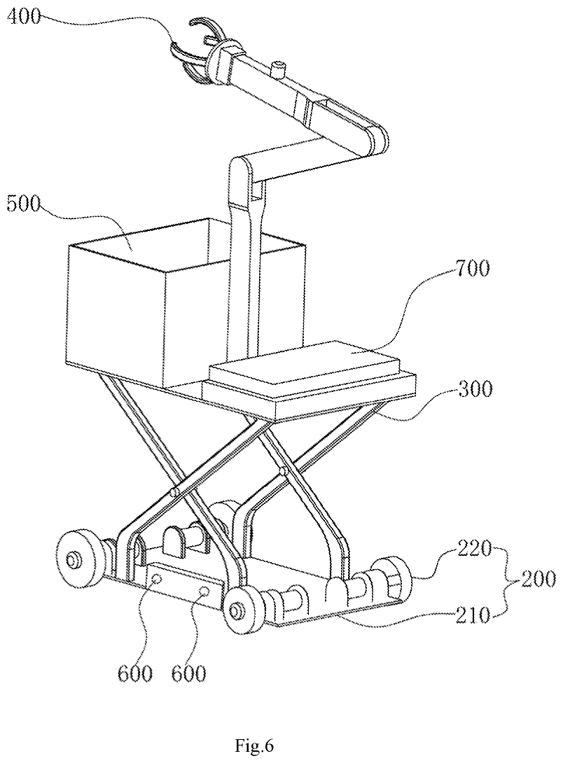

As shown in FIG. 6 which is a schematic structural diagram of a device for automatic shopping in a shopping mall according to an embodiment of the present disclosure.

A device for automatic shopping in a shopping mall is provided in an embodiment according to a fourth aspect of the present disclosure, including:

a mechanical body 800 including: a moving means 200 with a movement driving means 820 for driving the moving means 200 to walk; a lifting means 300 with a lift driving means 830 for driving the lifting means 300 to lift; and a pickup means 400 with a pickup driving means 840 for driving the pickup means 400 to operate;

an input means 920 for receiving consumers' selection of commodities;

a memory with one or more computer programs and a global map stored thereon; and

one or more processors for executing the computer programs to:

acquire commodity information of several selected commodities sent by the input means 920;

plan a path in the global map based on first coordinates carried in the commodity information of the several selected commodities;

control, by the processor based on the path, the movement driving means 820 to drive the moving means 200 to move according to the path;

control, by the processor based on height values of the several selected commodities on a shelf which are carried in the commodity information of the selected commodities, the lift driving means to driving the lifting means 300 to lift according to the height values; and

determine, by the processor according to acquired position information of the moving means 200 and height information of the lifting means 300, whether the position information corresponds to designated positions on the path and whether the height information corresponds to the corresponding height values, and if yes, control the pickup driving means 840 to drive the pickup means 400 to operate to pick up the commodities from the shelf.

In some embodiments, the input means 920 may be an operating terminal disposed in the shopping mall and having a touch screen, which is connected to the processor. A user selects products at the operating terminal and determines commodities to be purchased finally. The selected commodities are concentrated on a “shopping cart” menu page. The commodities on the “shopping cart” menu page are considered to be selected commodities, which will be sent to the processor when the consumer performs a confirmation operation on the operating terminal. Specifically, commodities in the shopping mall are displayed on the touch screen of the operating terminal. A part of commodity information of each commodity can be displayed corresponding to the commodity on the touch screen, including commodity name, picture, unit price and other information. The other part of the commodity information, which does not need to be displayed on the touch screen, includes first coordinates of the commodity on the global map of the shopping mall and a height value on the shelf.

In some other embodiments, to reduce the cost of time spent by consumers in the shopping mall, realize online ordering and get commodities upon arrival at the shopping mall, the selection of commodities in the supermarket can be realized through a mobile terminal device connected to the Internet. Smartphones and tablet computers can be used as the input means 920 for receiving consumers' selection of commodities. By running a corresponding APP (application) on the mobile terminal device, information about the commodities in the supermarket can be provided for the consumers through the phone APP, and the consumers can realize the selection of commodities in the supermarket on the phone APP. The selected commodities are also concentrated on the “shopping cart” menu page. When the consumers confirm the purchase in the APP, the selected commodities are sent to the processor via the Internet. Therefore, the device for automatic shopping in a shopping mall should be provided with a communication module connected to the Internet.

Data of global maps of the shopping mall is stored in the memory. The global maps should be built before the consumer makes a purchase, and then a coordinate position in the global map, that is, first coordinates, is assigned to each commodity in the shopping mall. An indoor global map may be built with a SLAM method, which uses a known motion model to start to move in an environment with a large number of road sign features from an unknown position. The motion model here is a two-wheel drive robot. The robot measures a relative distance between any single road sign and the robot according to a sensor it carries, and it is impossible to acquire an absolute position of the road sign. Meanwhile, maps are created incrementally, and then the robot is self-localized by using the known motion model and external environment feature information obtained by the sensor. As can be seen, due to significant differences between arrangement modes of shelves in different shopping malls, each shopping mall has its own unique environment. Maps can be automatically built for unknown environments with the SLAM method, which is of high universality.

Each commodity is correspondingly associated with its own corresponding commodity information, such as the commodity name, picture, unit price, first coordinates of the commodity in the global map of the shopping mall, and a height value on the shelf. However, when a movable robot or shopping cart is used to search for a corresponding commodity on the map, the movable robot or shopping cart should move to the front of the shelf where the commodity is located, and then picks the commodity from the position of the corresponding height value of the shelf at the first coordinates of the commodity by means of the lifting means 300 and the pickup means 400. Obviously, the movable robot or shopping cart is unlikely to occupy the first coordinates of the commodity. Therefore, position coordinates where the movable robot or shopping cart stops should be different from the first coordinates of the commodity. The coordinates where the movable robot or shopping cart stops for pickup are defined as second coordinates in the global map. Thus, the commodity information is also associated with second coordinates for the movable robot or shopping cart to stop for pickup.

It can be seen that the path planned based on the first coordinates should be a path formed by connecting the second coordinates associated with the commodity information of all selected commodities passed by the movable robot or shopping cart with the starting point and the ending point. The second coordinates of the commodity represents the direction and geometric distance between the moving means 200 and the first coordinates of the commodity, so the relationship between the second coordinates and the first coordinates of the same commodity should depend on the shape and structure of the movable robot or shopping cart. The movable robot or shopping cart should include four parts: a circuit board 700, the moving means 200, the lifting means 300 and the pickup means 400.

Shelves in a shopping mall are usually multi-layer shelves. Commodities in different layers on the same shelf have the same first coordinates, but different height values. It should be noted that the height value does not define a horizontal height of the commodity but is used to define a lifting height of the lifting means 300. The pickup means 400 is installed on the lifting means 300, so this height value actually means that the lifting means 300 lifts the pickup means 400 to a position corresponding to a respective commodity according to the height value.

It can be seen that, to pick the commodity from a corresponding layer of a corresponding shelf, two conditions must be met: the moving means 200 arrives at a designated position on the path, that is, the moving means 200 arrives at the corresponding second coordinates; moreover, the lifting means 300 drives the pickup means 400 to the height position corresponding to the height value of the commodity. When the two conditions are met, the pickup means 400 will start to operate to pick the commodity. If the moving means 200 does not arrive at the designated position, it will continue to move to the designated position; and if the lifting means 300 does not arrive at the height position corresponding to the height value of the commodity, it will continue the lifting operation.

In an embodiment, when the moving means 200 arrives at the corresponding second coordinates, that is, the moving means 200 stops moving, the lifting means 300 starts lifting. The pickup means 400 starts pickup when the lifting means 300 drives the pickup means 400 to arrive at the height position corresponding to the corresponding height value.

In another embodiment, to save the lifting time of the lifting means 300 and speed up the pickup, the lifting means 300 starts the lifting operation before the moving means 200 arrives at the corresponding second coordinates, that is, when the moving means 200 is still in the process of moving. After the moving means 200 arrives at the corresponding second coordinates, the lifting means 300 has been lifted to the height position corresponding to the height value of the second coordinates, and the pickup means 400 can start pickup immediately.

In some embodiments, the moving means 200 is embodied as a structure in which a motor is used to drive the wheels 220. Specifically, the moving means 200 includes a chassis 210 and four Mecanum wheels disposed on the chassis 210. A movement driving motor is used as the movement driving means 820, and the four Mecanum wheels are driven by the movement driving motor to coordinate with the moving means 200 for walking. Through the coordination of the four Mecanum wheels, the moving means 200 is capable of making flexible adjustment in multiple directions, which is conducive to adjusting the pose, and enables the moving means 200 to arrive at the second coordinates according to a preset pose, improving the localization accuracy. The moving means 200 may also be embodied by replacing the Mecanum wheels with ordinary wheels 220. In other embodiments, a moving means 200 with a tracked structure can also be used, and the implementation structure of the moving means 200 belongs to the prior art, which is not described in detail here.

In this embodiment, the lifting means 300 includes a lifting platform and a lifting cylinder for driving the lifting platform to lift, or a structure in which a lifting motor is used to drive a chain structure may be used by the lifting means 300 to drive the lifting platform to lift, and the pickup means 400 is installed on the lifting platform. The implementation structure of the lifting means 300 belongs to the prior art, which is not described in detail here.

Specifically, the shelf is divided into multiple layers according to the horizontal height, each layer is provided with multiple storage tanks along the horizontal direction, a front end of each of the storage tanks is provided with a delivery port, the front end of the storage tank faces towards the pickup means 400 when stopping for pickup, and the storage tank is provided with a delivery mechanism for driving commodities in the storage tank to move to the delivery port. The delivery mechanism may be a conveyor belt. Commodities in the storage tank are on the conveyor belt which transports the commodities to the delivery port, and infrared sensors are disposed on opposite sides of the delivery port for measuring whether there are commodities in the delivery port. When the pickup means 400 picks the commodities in the delivery port, the infrared sensors detect that the delivery port are empty now, and send a signal to the processor. The processor controls the conveyor belt to transport commodities forward to the delivery port to ensure that there are commodities in the delivery port all the time, enabling the pickup means 400 to pick up commodities from preset positions. Definitely, in addition to the conveyor belt, the delivery mechanism may also use a push rod driven by a cylinder to push the commodities to the delivery port.

In this embodiment, the pickup means 400 is installed on the lifting platform of the lifting means 300. The pickup means 400 includes a support plate or a support rod that can extend and contract in the direction of the delivery port. For commodities with a flat bottom placed at the delivery port, for example, boxed drinks, the pickup means 400 uses a pickup cylinder to drive the support plate. The support plate is driven by the pickup cylinder to extend into the delivery port and pick the boxed drinks, and then the support plate is driven by the lifting means 300 to be lifted to an accommodation space 500 of the robot or shopping cart. The support plate is tilted under the control of a tilting motor to send the boxed drinks into the accommodation space 500. For commodities packaged in plastic bags, the pickup means 400 uses the pickup cylinder to drive the support rod. The support rod is driven by the pickup cylinder to extend into the delivery port and into a handle position of a plastic bag to pick the plastic bag. The support rod is somewhat curved to facilitate pickup of the plastic bags from the storage tank, and then the support rod is driven by the lifting means 300 to be lifted to the accommodation space 500 of the robot or shopping cart. The support rod is tilted under the control of the tilting motor to send the plastic bags into the accommodation space 500. In other embodiments, a pneumatic finger can also be used to extend into the delivery port to grab the corresponding commodities. It should be noted that the structure of the pickup means 400 should be designed according to shape characteristics of the commodities.

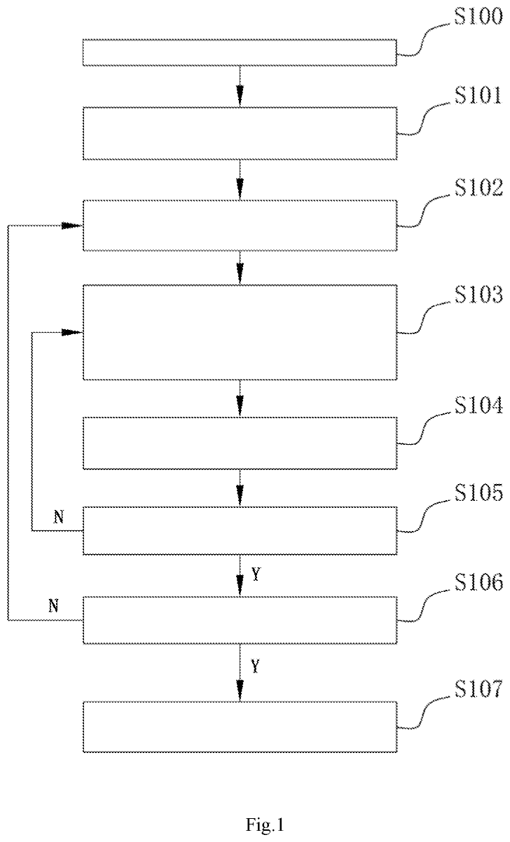

FIG. 1 shows a flowchart of a method for automatic shopping in a shopping mall according to an embodiment of the present disclosure.

A method for automatic shopping in a shopping mall is provided in an embodiment according to a first aspect of the present disclosure, including:

step S100: acquiring commodity information of several selected commodities;

step S101: planning a path based on first coordinates carried in the commodity information of the several selected commodities;

step S102: sending, based on the path, a movement instruction for controlling a moving means 200 to move;

step S103: sending, based on height values of the several selected commodities on a shelf which are carried in the commodity information of the selected commodities, a lifting instruction for controlling a lifting means 300 to lift; and

step S104: acquiring position information of the moving means 200 and height information of the lifting means 300;

step S105: determining whether the position information corresponds to designated positions on the path;

step S106: determining whether the height information corresponds to the corresponding height values; and

if the results of step S105 and step S106 are both yes,

performing step S107: sending an automatic pickup command to control a pickup means 400 to pick up the commodities from the shelf.

If the result of step S105 is no, the process goes back to step S103; if the result of step S106 is no, the process goes back to step S102.

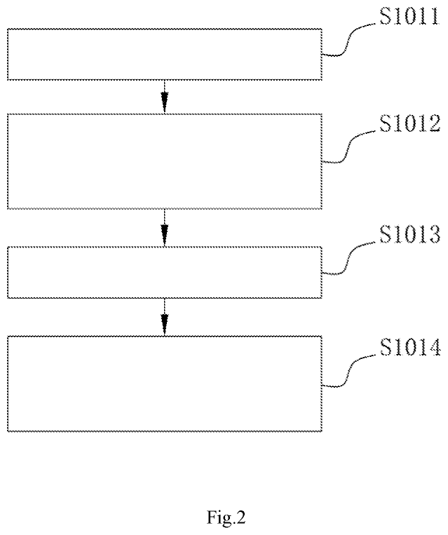

Specifically, FIG. 2 shows a method flowchart of planning a path in a method for automatic shopping in a shopping mall according to an embodiment of the present disclosure.

Step S101 includes:

step S1011: acquiring first coordinates carried in the commodity information of the several selected commodities;

step S1012: generating second coordinates in one-to-one correspondence with the first coordinates based on the first coordinates carried in the commodity information of the several selected commodities;

step S1013: acquiring a third coordinate of the moving means 200 at a starting point; and

step S1014: generating the path based on the third coordinate and the second coordinates, the path starting from the third coordinate and passing through all the second coordinates.

Obviously, the movable robot or shopping cart is unlikely to occupy the first coordinates of the commodities. Therefore, position coordinates where the movable robot or shopping cart stops should be different from the first coordinates of the commodities. The coordinates where the movable robot or shopping cart stops for pickup is defined as second coordinates in the global map. Thus, the commodity information is also associated with second coordinates for the movable robot or shopping cart to stop for pickup. By setting the second coordinates as coordinate points where the moving means stops moving during pickup, it is convenient to adjust the distance between the second coordinates and the first coordinates reasonably according to the size of the space occupied by the moving means 200, so as to enhance the universality of this method.

In some optional embodiments, the path may be planned as follows: acquiring second coordinates in the commodity information according to an order of the selected commodities, and planning the path of the moving means 200 according to an order of acquisition of the second coordinates. For example, it is assumed that an order in which consumers choose three commodities named A1, A2 and A3 is A1, A2 and A3, second coordinates corresponding to A1, A2 and A3 are (a1, b1), (a2, b2) and (a3, c3), and a starting point coordinate of the moving means 200 is the third coordinate (a0, b0), wherein the starting point coordinate is the same as an ending point coordinate of the moving means 200. Then, the path of the moving means 200 planned by the moving means 200 according to an order of acquisition of the second coordinates travels through (a0, b0), (a1, b1), (a2, b2), (a3, c3) and (a0, b0) in sequence.

In other embodiments, the path may be planned as follows: starting from the starting point (a0, b0), establishing an unpassed coordinate data set from all the second coordinates that are required to pass through for the task; removing a second coordinate (c1, d1) from the unpassed coordinate data set when the second coordinate (c1, d1) in the unpassed coordinate data set is reached, and calculating a linear distance in the global map by using the removed second coordinate (c1, d1) and a second coordinate (c2, d2) in the unpassed coordinate data set; and taking a second coordinate (c2, d2) with the shortest distance from the second coordinate (c1, d1) as the next second coordinate (c2, d2) that needs to be passed through. The next passing point is set to be an ending point (a0, b0) when the unpassed coordinate data set is empty.

It can be seen that the time cost of a single pickup can be considered as consisting of the time for the moving means 200 to move along the path and the time for the pickup means 400 to pick the commodities from the shelf. The time spent by the pickup means 400 to pick the commodities from the shelf shall include the time for the lifting means 300 to lift to a corresponding height and the time for the pickup means 400 to pick and put the commodities into the accommodation space 500. In the above embodiment, by controlling the lifting means 300 to lift to a height value corresponding to the commodity associated with a next second coordinate during the movement of the moving means 200 to the next second coordinate, the lifting cost caused by the operation of the lifting device 300 is saved.

Further, to shorten the time for the moving means 200 to move along the path, a related model may be used to study the path planning problem, which can be regarded as a classical TSP (Traveling Salesman Problem). TSP can be described as follows: a salesman is going to a number of cities to sell commodities, starting from a city and returning to the place of departure after travelling all the required cities. The problem is how to select a traveling route to minimize the total travel.

For TSP, there are path planning solutions such as ant colony algorithm, approximation algorithm, genetic algorithm, simulated annealing algorithm, neural network, etc. Through these path planning solutions, the path passed by the moving means 200 is relatively optimized, which can be realized by a person skilled in the art through existing algorithms. Due to the limited space, they are not elaborated here.

After the path is planned, the movement of the moving means 200 on the path can be divided into multiple segments each regarded as a localization solution for the movement from a current second coordinate (e1, f1) to a next second coordinate (e2, f2) on the path.

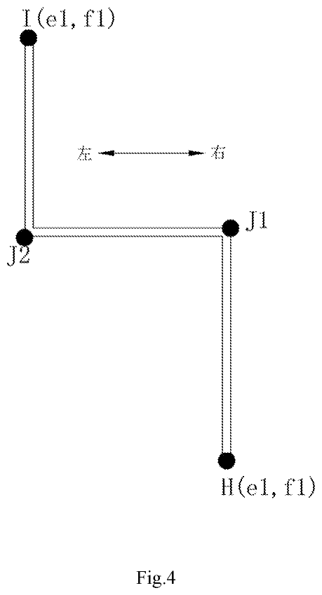

In an optional embodiment, as shown in FIG. 4 which is a schematic diagram of a localization solution for a moving means 200 in a method for automatic shopping in a shopping mall according to an embodiment of the present disclosure, solution for localization of the movement from the current second coordinate H (e1, f1) to the next second coordinate I (e2, f2) on the path is as follows.

A speed sensor is equipped on the moving means 200. An advancing distance is calculated proportionally according to the path planned on the global map, for example, from a starting point H (e1, f1) to a turning point J1, which is 30 m in the map according to the scale. The shopping cart will travel in a straight line from H (e1, f1) to the turning point J1, and turn left after 30 m according to the formula of speed-displacement. Then, it goes straight 30 m from the turning point J1 to a turning point J2. Similarly, it finally goes straight from J2 to I (e2, f2). Motion displacement on the straight line calculated using speed sensor data has a good effect. In particular, the structural accuracy of linear uniform motion calculation is high.

In another optional embodiment, solution for localization of the movement from a current second coordinate B0 (e3, f3) to a next second coordinate B3 (e4, f4) on the path is as follows.

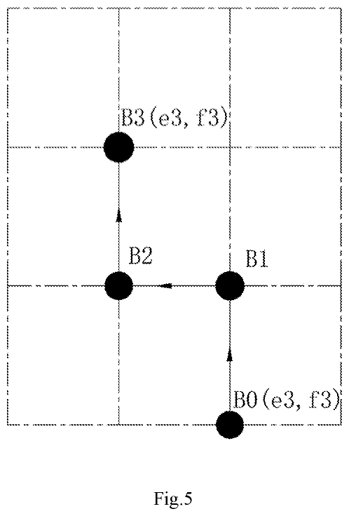

On the basis of the solution of equipping a speed sensor on the moving means 200 to coordinate with the map to calculate a displacement proportionally, to reduce influences of a measurement error of the speed sensor at the turning point due to large speed change on the localization accuracy, an optical signal generator is disposed in the shopping mall at a position corresponding to the position of the turning point on the global map, to send different coordinate signals to the moving means 200 for determining its current position. Specifically, the optical signal generator may be disposed at the turning point, a photodetector for receiving optical signals is installed on the moving means 200, and the signal generated by the optical signal generator at each turning point is unique. Therefore, it can be determined, by the processor, which turning point it is currently located according to the optical signal received by the photodetector on the moving means 200. FIG. 5 is a schematic diagram of a localization solution for the moving means 200 in a method for automatic shopping in a shopping mall according to another embodiment of the present disclosure. Assuming that the solid line in FIG. 5 is the planned path, it is necessary to sequentially pass through sensors B1 and B2 to reach a target position B3 in the path. The coordinate of B3 is (e4, f4). The moving means 200 travels from the starting point B0 (e3, f3) to the position of B1, receives a signal at B1 and considers that it reaches the point of B1, then adjusts a traveling direction based on the coordinates of the sensors on the global map and the relationship between the sensors, and moves to B2 until a final target (e4, f4) is finally reached.

On the basis of the localization solution for the moving means 200 provided above, it can be seen that the processor can acquire position information of the moving means 200 in real time according to the calculation of speed during moving and the interaction of sensor signals at the turning point. Meanwhile, the lifting means 300 is driven by a lifting motor. In order to acquire height information of the lifting means 300 in real time, a servo driver is used to drive the lifting motor. The servo driver will feed back the state of the lifting motor in real time, so that the processor can acquire the height information of the lifting means 300 in real time. Through the monitoring on the servo driver, an encoder built in the lifting motor feeds back a signal to the servo driver. The servo driver compares a feedback value with a target value. When the feedback value is equal to the target value, the height information of the lifting means 300 is considered to reach the corresponding height value.

After the position information of the moving means 200 and the height information of the lifting means 300 are acquired, the processor determines whether the position information corresponds to designated positions on the path and whether the height information corresponds to the corresponding height values, and if yes, the processor sends to the pickup means 400 an automatic pickup instruction for controlling the pickup means 400 to pick up commodities from the shelf.

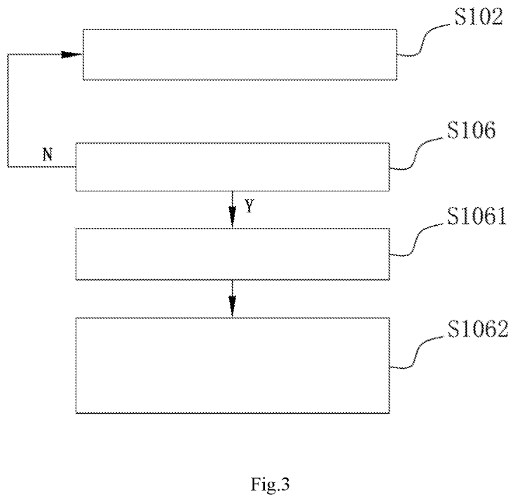

FIG. 3 is a method flowchart of adjusting pose of the moving means in a method for automatic shopping in a shopping mall according to an embodiment of the present disclosure. In some optional embodiments, to improve the localization accuracy of the moving means 200, after the position information of the moving means 200 is acquired, the processor performs step S106: determining whether the position information corresponds to designated positions on the path, and if yes, performing the following steps:

step S1061: acquiring pose data of the moving means 200; and

step S1062: sending, based on the acquired pose data of the moving means 200, an pose adjustment instruction for controlling the moving means 200 to adjust pose.

In an embodiment, two ranging sensors 850, 600 are disposed on one side of the moving means 200 facing the shelf. When the moving means 200 arrives at a second coordinate on the path, the two ranging sensors 850, 600 simultaneously measure a distance from the shelf. One side of the shelf facing the cart is required to be a plane. The two ranging sensors 850, 600 of the moving means 200 are installed on the plane of the side of the moving means 200 facing the shelf. Pose of the moving means 200 can be obtained by comparing data of the two ranging sensors 850, 600. For example, the standard pose is required to be that the plane of the side of the moving means 200 facing the shelf is parallel to one side of the shelf facing the cart, and then a corresponding instruction is sent to the movement driving motor of the moving means 200 to control the moving means 200 to adjust its direction and pose. Definitely, the number of the ranging sensors 850, 600 includes, but is not limited to, three or four.

In another embodiment, the shelf where the commodity corresponding to a next second coordinate on the path that the moving means 200 needs to arrive at is located is defined as a target shelf. After the moving means 200 arrives at the next second coordinate corresponding to the commodity, a wall or a shelf other than the target shelf which faces the moving means 200 is defined as a reference surface, and the target shelf and the reference surface are located at opposite sides of the moving means 200, respectively. Two groups of ranging units are disposed on opposite sides of the moving means 200 facing the target shelf and the reference surface respectively, and each group of ranging units includes more than two ranging sensors 850, 600. The two ranging sensors 850, 600 of the ranging units facing one side of the target shelf simultaneously measure a distance from the target shelf. One side of the target shelf facing the cart is required to be a plane. The two ranging sensors 850, 600 of the moving means 200 are installed on the plane of the side of the moving means 200 facing the target shelf. Pose of the moving means 200 can be obtained by comparing data of the two ranging sensors 850, 600. Meanwhile, the two ranging sensors 850, 600 of the ranging units facing the reference surface also simultaneously measure a distance from the reference surface, and the accuracy of pose adjustment is further improved by calculating the data of the two ranging units, thus improving the accuracy of localization.

After the pose of the moving means 200 is adjusted as standard pose, the processor sends to the pickup means 400 an automatic pickup instruction for controlling the pickup means 400 to pick up commodities from the shelf. Since the moving means 200 drives the lifting means 300 and the pickup means 400 to move to the standard pose now, the pickup accuracy of the pickup means 400 can be improved.

In some optional embodiments, before the step of planning a path based on first coordinates carried in the commodity information of the several selected commodities is performed, the method further includes: calculating the total price of the selected commodities based on unit prices carried in the commodity information of the several selected commodities; and sending a payment request matched with the total price, detecting whether the payment is successful, and if yes, performing the step of planning a path based on first coordinates carried in the commodity information of the several selected commodities. In this embodiment, a step of paying before purchasing is set to reduce the cost of shopping mall management.

In some embodiments, there may be a method of purchasing before paying, in which the consumer uses the device for automatic shopping in a shopping mall provided in the embodiments of the present disclosure to pick all the selected commodities from the shelves of the shopping mall through a movable robot or shopping cart, and then pays the corresponding money.

A computer readable storage medium having a computer program stored thereon is provided in an embodiment according to a second aspect of the present disclosure, wherein when the computer program is executed by a processor, the method for automatic shopping in a shopping mall in the embodiment of the first aspect of the present disclosure is performed. Therefore, the embodiment of the second aspect of the present disclosure has all the beneficial effects of the embodiment of the first aspect of the present disclosure.

An electronic device 910 is provided in an embodiment according to a third aspect of the present disclosure, including: one or more processors; and a storage device for storing one or more programs which, when executed by the one or more processors, cause the one or more processors to perform the method for automatic shopping in a shopping mall in the embodiment of the first aspect of the present disclosure. Therefore, the embodiment of the third aspect of the present disclosure has all the beneficial effects of the embodiment of the first aspect of the present disclosure.

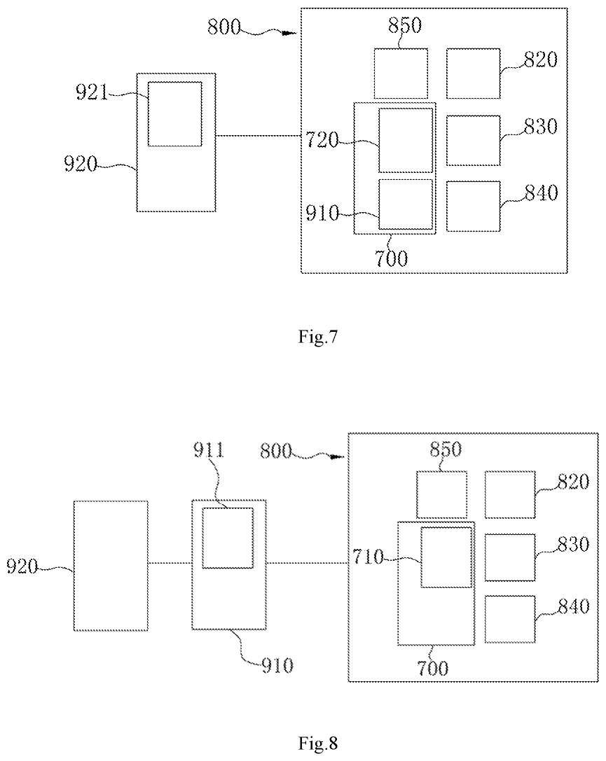

FIG. 7 is a system block diagram of a device for automatic shopping in a shopping mall according to an embodiment of the present disclosure. In some embodiments, the electronic device 910 is disposed on a circuit board 700 of a movable robot or shopping cart. The circuit board 700 is provided with a first wireless communication module 720 for the electronic device to communicate with a second wireless communication module 921 of an input means 920.

FIG. 8 is a system block diagram of a device for automatic shopping in a shopping mall according to another embodiment of the present disclosure. In some other embodiments, the electronic device 910 is disposed separately from the movable robot or shopping cart. In this case, the circuit board 700 is provided with a third wireless communication module 710, and the electronic device 910 is provided with a fourth wireless communication module 911. The electronic device 910 communicates with the third wireless communication module 710 through the fourth wireless communication module 911, so as to control the movement, lifting and pickup of the movable robot or shopping cart.

The embodiments of the present disclosure are described above in detail with reference to the accompanying drawings, but the present disclosure is not limited to the above embodiments. Various changes can be made without departing from the purpose of the present disclosure within the scope of the knowledge possessed by a person of ordinary skill in the art.

We claim:

1. A method for automatic shopping in a shopping mall, comprising:
acquiring commodity information of several selected commodities;
planning a path based on first coordinates carried in the commodity information of the several selected commodities;
sending, based on the path, a movement instruction for controlling a moving means to move;
sending, based on height values of the several selected commodities on a shelf which are carried in the commodity information of the selected commodities, a lifting instruction for controlling a lifting means to lift; and
acquiring position information of the moving means and height information of the lifting means, determining whether the position information corresponds to designated positions on the path and whether the height information corresponds to the corresponding height values, and if yes, sending an automatic pickup command to control a pickup means to pick up the commodities from the shelf.

2. The method for automatic shopping in a shopping mall of claim 1, wherein after the result of determining whether the position information corresponds to designated positions on the path is yes, the method further comprises:
acquiring pose data of the moving means; and
sending, based on the acquired pose data of the moving means, an pose adjustment instruction for controlling the moving means to adjust pose.

3. The method for automatic shopping in a shopping mall of claim 1, wherein the planning a path based on first coordinates carried in the commodity information of the several selected commodities comprises:
acquiring the first coordinates carried in the commodity information of the several selected commodities;
generating second coordinates in one-to-one correspondence with the first coordinates based on the first coordinates carried in the commodity information of the several selected commodities;
acquiring a third coordinate of the moving means at a starting point; and
generating the path based on the third coordinate and the second coordinates, the path starting from the third coordinate and passing through all the second coordinates.

4. The method for automatic shopping in a shopping mall of claim 1, wherein before the step of planning a path based on first coordinates carried in the commodity information of the several selected commodities is performed, the method further comprises:
calculating a total price of the selected commodities based on unit prices carried in the commodity information of the several selected commodities; and
sending a payment request matched with the total price, detecting whether the payment is successful, and if yes, performing the step of planning a path based on first coordinates carried in the commodity information of the several selected commodities.

5. A computer readable storage medium, having a computer program stored thereon which, when executed by a processor, cause the processor to perform steps of:
acquiring commodity information of several selected commodities;
planning a path based on first coordinates carried in the commodity information of the several selected commodities;
sending, based on the path, a movement instruction for controlling a moving means to move;
sending, based on height values of the several selected commodities on a shelf which are carried in the commodity information of the selected commodities, a lifting instruction for controlling a lifting means to lift; and
acquiring position information of the moving means and height information of the lifting means, determining whether the position information corresponds to designated positions on the path and whether the height information corresponds to the corresponding height values, and if yes, sending an automatic pickup command to control a pickup means to pick up the commodities from the shelf.

6. The computer readable storage medium of claim 5, wherein after the result of determining whether the position information corresponds to designated positions on the path is yes, the method further comprises:
acquiring pose data of the moving means; and
sending, based on the acquired pose data of the moving means, an pose adjustment instruction for controlling the moving means to adjust pose.

7. The computer readable storage medium of claim 5, wherein the planning a path based on first coordinates carried in the commodity information of the several selected commodities comprises:
acquiring the first coordinates carried in the commodity information of the several selected commodities;
generating second coordinates in one-to-one correspondence with the first coordinates based on the first coordinates carried in the commodity information of the several selected commodities;
acquiring a third coordinate of the moving means at a starting point; and
generating the path based on the third coordinate and the second coordinates, the path starting from the third coordinate and passing through all the second coordinates.

8. The computer readable storage medium of claim 5, wherein before the step of planning a path based on first coordinates carried in the commodity information of the several selected commodities is performed, the method further comprises:
calculating a total price of the selected commodities based on unit prices carried in the commodity information of the several selected commodities; and
sending a payment request matched with the total price, detecting whether the payment is successful, and if yes, performing the step of planning a path based on first coordinates carried in the commodity information of the several selected commodities.

9. A device for automatic shopping in a shopping mall, comprising:
a mechanical body comprising:
a moving means provided with a movement driving means for driving the moving means to walk,
a lifting means provided with a lift driving means for driving the lifting means to lift, and
a pickup means provided with a pickup driving means for driving the pickup means to operate;
an input means for receiving consumers' selection of commodities;
a memory storing one or more computer programs and a global map; and
one or more processors for executing the computer programs to:
acquire commodity information of several selected commodities sent by the input means;
plan a path in the global map based on first coordinates carried in the commodity information of the several selected commodities;
control, by the processor based on the path, the movement driving means to drive the moving means to move according to the path;
control, by the processor based on height values of the several selected commodities on a shelf which are carried in the commodity information of the selected commodities, the lift driving means to driving the lifting means to lift according to the height values; and
determine, by the processor according to acquired position information of the moving means and height information of the lifting means, whether the position information corresponds to designated positions on the path and whether the height information corresponds to the corresponding height values, and if yes, control the pickup driving means to drive the pickup means to operate to pick up the commodities from the shelf.

10. The device for automatic shopping in a shopping mall of claim 9, wherein the moving means is provided with more than two ranging sensors facing towards one side of the shelf.

11. The device for automatic shopping in a shopping mall of claim 9, wherein the shelf is provided with multiple storage tanks, a front end of each of the storage tanks is provided with a delivery port, and the storage tank is provided with a delivery mechanism for driving commodities in the storage tank to move to the delivery port.

12. The device for automatic shopping in a shopping mall of claim 9, wherein the moving means comprises a chassis and four Mecanum wheels disposed on the chassis.
